(19) United States
(12) Patent Application Publication
(10) Pub. No.: US 2024/0390797 A1
(43) Pub. Date: Nov. 28, 2024

(54) VIRTUAL OBJECT GENERATION METHOD

(71) Applicant: Tencent Technology (Shenzhen) Company Limited, Shenzhen (CN)

(72) Inventors: Yiqi LI, Shenzhen (CN); Han WEN, Shenzhen (CN); Ya ZHANG, Shenzhen (CN); Luyu SUN, Shenzhen (CN); Yinchao CHEN, Shenzhen (CN)

(73) Assignee: Tencent Technology (Shenzhen) Company Limited, Shenzhen (CN)

(21) Appl. No.: 18/796,057

(22) Filed: Aug. 6, 2024

Related U.S. Application Data
(63) Continuation of application No. PCT/CN2023/114373, filed on Aug. 23, 2023.

(30) Foreign Application Priority Data
Sep. 23, 2022 (CN) 202211167590.8

(51) Int. Cl. A63F 13/63; A63F 13/5372; A63F 13/55; G06T 17/00

(52) U.S. Cl. CPC A63F 13/63; A63F 13/5372; A63F 13/55; G06T 17/00

(57) ABSTRACT

In a virtual object generation method, an object generation operation is received from a user account to generate a virtual object group including a specified quantity of virtual objects to be controlled by the user account. When second virtual objects are determined to be generated as part of the virtual object group, a generation result of first virtual objects is displayed in the virtual object group based on the object generation operation, and a generation result of second virtual objects is displayed. A total quantity of the first virtual objects and the second virtual objects is the specified quantity of the virtual objects, whether the second virtual objects are to be generated in the virtual object group is determined independently of the object generation operation. A first object attribute information corresponding to the first virtual objects is different from a second object attribute information corresponding to the second virtual objects.

### RELATED APPLICATION

The present application is a continuation of International Application No. PCT/CN2023/114373, “VIRTUAL OBJECT GENERATION METHOD AND APPARATUS, DEVICE, MEDIUM, AND PROGRAM PRODUCT,” filed on Aug. 23, 2023, which claims priority to Chinese Patent Application No. 202211167590.8, filed on Sep. 23, 2022, and entitled “VIRTUAL OBJECT GENERATION METHOD AND APPARATUS, DEVICE, MEDIUM, AND PROGRAM PRODUCT”. The entire disclosures of the prior applications are hereby incorporated by reference.

### FIELD OF THE TECHNOLOGY

This application relates to the field of interface interaction, including a virtual object generation method.

### BACKGROUND OF THE DISCLOSURE

A strategy game is a game centered around achieving various forms of victory. In a war-themed strategy game, a player needs to contemplate various complex issues and control different virtual objects to fight to achieve victory.

In related art, a combat attribute of a virtual object is correlated with factors such as a type of the virtual object, a level of a player controlling the current virtual object, and a faction of the virtual object. Growth of the virtual object depends on factors such as increase of the level of the player controlling the current virtual object and increase of a level of the faction of the virtual object.

However, a growth pattern of virtual objects is fixed. Combat attributes of virtual objects of the same type, same level, and same faction are basically the same, resulting in an undiversified growth process of the virtual objects.

### SUMMARY

Embodiments of this disclosure include a virtual object generation method, apparatus, and a non-transitory computer-readable storage medium. Examples of technical solutions in the embodiments of this disclosure may be implemented as follows:

An aspect of this disclosure provides a virtual object generation method, performed by an electronic device, for example, in a virtual object generation method, an object generation operation is received from a user account to generate a virtual object group including a specified quantity of virtual objects to be controlled by the user account. When second virtual objects are determined to be generated as part of the virtual object group, a generation result of first virtual objects is displayed in the virtual object group based on the object generation operation. A generation result of second virtual objects is displayed. A total quantity of the first virtual objects and the second virtual objects is the specified quantity of the virtual objects, whether the second virtual objects are to be generated in the virtual object group is determined based on one or more factors independent of the object generation operation, and a first object attribute information corresponding to the first virtual objects is different from a second object attribute information corresponding to the second virtual objects.

An aspect of this disclosure provides a virtual object generation apparatus, including processing circuitry. The processing circuitry is configured to receive an object generation operation from a user account to generate a virtual object group including a specified quantity of virtual objects to be controlled by the user account. When second virtual objects are determined to be generated as part of the virtual object group, the processing circuitry is configured to display a generation result of first virtual objects in the virtual object group based on the object generation operation, and the processing circuitry is configured to display a generation result of second virtual objects. A total quantity of the first virtual objects and the second virtual objects is the specified quantity of the virtual objects, whether the second virtual objects are to be generated in the virtual object group is determined based on one or more factors independent of the object generation operation, and a first object attribute information corresponding to the first virtual objects is different from a second object attribute information corresponding to the second virtual objects.

An aspect of this disclosure provides a non-transitory computer-readable storage medium storing instructions which when executed by a processor cause the processor to perform any of the methods of this disclosure.

The technical solutions provided in embodiments of this disclosure have at least the following beneficial effects:

In a process of generating a first virtual object, a second virtual object is randomly generated, and the second virtual object has an object attribute different from that of the first virtual object. According to this disclosure, randomness in growth of virtual objects is increased, so that growth patterns of the virtual objects are diversified, thereby increasing interestingness and topicality of controlling the virtual objects. The use of “randomly” throughout the disclosure corresponds to a function performed independently of user input.

### BRIEF DESCRIPTION OF THE DRAWINGS

FIG. 1 is a schematic diagram of generation of virtual objects according to an embodiment.

FIG. 2 is a block diagram of a structure of an electronic device according to an embodiment.

FIG. 3 is a schematic diagram of an implementation environment according to an embodiment.

FIG. 4 is a flowchart of a virtual object generation method according to an embodiment.

FIG. 5 is a schematic diagram of a virtual object generation method according to an embodiment.

FIG. 6 is a flowchart of a method for displaying a generation result of a second virtual object according to the embodiment shown in FIG. 4.

FIG. 7 is a schematic diagram of displaying prompt information corresponding to a second virtual object according to an embodiment.

FIG. 8 is a schematic diagram of a second virtual object located at an arrangement center of first virtual objects according to an embodiment.

FIG. 9 is a flowchart of a logical method for generating a first virtual object and a second virtual object according to another embodiment.

FIG. 10 is a logical schematic diagram of randomly generating a second virtual object according to another embodiment.

FIG. 11 is a flowchart of a growth method for a second virtual object participating in a virtual battle according to another embodiment.

FIG. 12 is a schematic diagram of providing an increase of experience points for a second object attribute of a second virtual object by N times according to another embodiment.

FIG. 13 is a schematic diagram of virtual objects of a home faction defeating virtual objects of an opposing faction according to another embodiment.

FIG. 14 is a schematic diagram of battle reward information generation logic according to another embodiment.

FIG. 15 is a block diagram of a structure of a virtual object generation apparatus according to an embodiment.

FIG. 16 is a block diagram of a structure of a virtual object generation apparatus according to another embodiment.

FIG. 17 is a block diagram of a structure of a computer device according to an embodiment.

### DESCRIPTION OF EMBODIMENTS

The objectives, technical solutions, and advantages in embodiments of this disclosure are described in detail with reference to the accompanying drawings. The described embodiments are some of the embodiments of this disclosure rather than all of the embodiments. Other embodiments are within the scope of this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

Before introducing the technical solutions of this disclosure, examples of terms involved in this disclosure are first explained and described. The descriptions of the terms are provided as examples only and are not intended to limit the scope of the disclosure. The following related explanations may be combined in different manners with the technical solutions of embodiments of this disclosure, and all combinations fall within the protection scope of embodiments of this disclosure. Embodiments of this disclosure include at least part of the following content.

Virtual object: It is a movable object or an immovable object in a virtual environment. The movable object may be at least one of a virtual character, a virtual animal, or a cartoon character. The immovable object may be at least one of a virtual building, a virtual plant, or a virtual terrain. In one embodiment, when the virtual environment is a three-dimensional virtual environment, the virtual object may be a three-dimensional virtual model. Each virtual object has its own shape and volume in the three-dimensional virtual environment, and occupies a part of space in the three-dimensional virtual environment. An activity of the virtual object includes but is not limited to: at least one of adjusting a body posture, crawling, walking, running, riding, flying, jumping, driving, picking up, shooting, attacking, or throwing. In one embodiment, the virtual object is a three-dimensional character built based on a three-dimensional human skeleton technology. The virtual object achieves different external figures by wearing different skins. In some implementations, the virtual object may alternatively be implemented by using a two-and-a-half-dimensional or a two-dimensional model. This is not limited in embodiments of this disclosure. For example, virtual objects may be classified into user-controlled virtual objects and server-controlled virtual objects based on different virtual object control manners. The user-controlled virtual object is an object that is movable in the virtual environment and controlled by a client. The server-controlled virtual object is a virtual object controlled by an automatic control algorithm or an AI program on the client or a server. The server-controlled virtual objects include movable objects and immovable objects in the virtual environment. For example, the immovable object may respond to or affect an activity of the movable object. For example, the movable object may destroy the immovable object, or the movable object is in an invisible state when the movable object moves into the immovable object. For example, a first virtual object and a second virtual object in this disclosure are user-controlled virtual objects.

The virtual environment (virtual scene) is a scene displayed (or provided) when a client of a target application (such as a game application) is run on a terminal device. The virtual environment may refer to an environment created to allow the virtual object to carry out an activity (such as game competition), such as a virtual house, a virtual island, and a virtual map. In one embodiment, the virtual environment is an environment displayed (or provided) when an application is run on a terminal device. The virtual environment may be a simulated world of the real world, a semi-simulated and semi-fictional three-dimensional world, or a completely fictional three-dimensional world. The virtual environment may be any one of a two-dimensional virtual environment, a two-and-a-half-dimensional virtual environment, and a three-dimensional virtual environment. In one embodiment, the virtual environment is further configured for allowing for a virtual environment battle between at least two virtual objects, and there are virtual resources available for use by the at least two virtual objects in the virtual environment.

User interface (UI for short) control: It is any visual control or element that can be seen on a user interface of an application, for example, a control such as a picture, an input box, a text box, a button, and a label. Some of these UI controls are responsive to user operations. For example, a shortcut operation control sends notification information to a client corresponding to a teammate in response to an operation on the shortcut operation control. A UI control in embodiments of this disclosure includes but is not limited to the shortcut operation control.

In a game application or some applications based on virtual scenes, a player can usually control a virtual object to carry out various actions in a virtual scene, or the player can control the virtual object to interact with another virtual object in the virtual scene, or the player can control the growth of the virtual object.

For example, the player can control a controlled virtual object to engage in a virtual battle interaction against a virtual object controlled by another player in the virtual scene, and may also control the controlled virtual object to interact with a non-player character (NPC for short) in the virtual scene.

The player may also control the controlled virtual object to use various virtual items to interact with another virtual object in the virtual scene, for example, use a virtual item to attack an opposing virtual object.

The player may also make the controlled virtual object grow by raising an object attribute level of the controlled virtual object.

In an example in which the player controls the growth of the virtual object, the player can make the virtual object grow and level up synchronously by raising a level of the player, raising a level of an area managed by the player, raising a level of the player's faction, and the like.

However, in related art, during growth of virtual objects, levels of virtual objects of a same type depend on a level of a player, a level of an area managed by the player, and a level of a faction of the player. In other words, the virtual objects grow with the increase of the player's level, the level of the area managed by the player, the level of the faction of the player, and another factor. In other words, a growth pattern of the virtual objects is fixed. In addition, object attributes of virtual objects of the same type, same level, and same faction are basically the same, so that a growth process of the virtual objects lacks diversity and randomness. As a result, a process of the player controlling the virtual object to fight is less interesting.

In embodiments of this disclosure, a special virtual object, that is, the second virtual object, is randomly generated to distinguish the second virtual object from an ordinary virtual object, that is, the first virtual object. The second virtual object has an object attribute different from that of the first virtual object. The object attribute of the second virtual object may be superior to the object attribute of the first virtual object, or may be inferior to the object attribute of the first virtual object. The second virtual object can grow by participating in a virtual battle and gaining experience points for the object attribute. In this way, an inherent growth pattern of virtual objects is broken through, and randomness in growth of the virtual objects is increased, so that growth patterns of the virtual objects are diversified, and interestingness and topicality of controlling the virtual objects are increased.

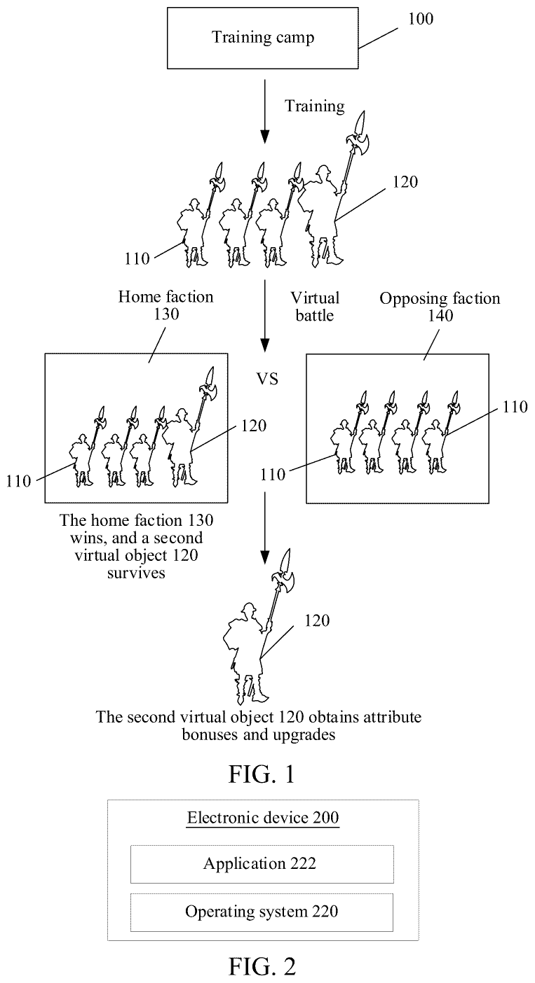

For example, as shown in FIG. 1, a virtual scene includes a virtual training camp 100. After an object generation instruction, that is, a training instruction, is received, a preset quantity of virtual objects in the virtual training camp 100 is trained, and different types of virtual objects are to be generated. For example, a first virtual object 110 and a second virtual object 120 are trained in the virtual training camp 100.

The second virtual object 120 is randomly generated. In a training result of the virtual training camp 100, there is at most one second virtual object 120, and the remaining virtual objects are the first virtual objects 110.

The first virtual object 110 has a first object attribute, the second virtual object 120 has a second object attribute, and the second object attribute is different from the first object attribute. The second object attribute may be superior to the first object attribute, or may be inferior to the first object attribute. The first virtual object 110 and the second virtual object 120 that a current control account possesses are in a home faction 130.

After a virtual battle instruction is received, virtual objects in the home faction 130 engage in a virtual battle against virtual objects in an opposing faction 140. If the home faction 130 wins the virtual battle and the second virtual object 120 survives, the second object attribute of the second virtual object 120 obtains corresponding experience points and gets an increase. If the obtained experience points reach a preset threshold, the second virtual object 120 is upgraded.

A computer device of this application includes a terminal device and a server. The terminal device may be a desktop computer, a portable laptop computer, a mobile phone, a tablet computer, an e-book reader, a Moving Picture Experts Group Audio Layer III (MP3) player, a Moving Picture Experts Group Audio Layer IV (MP4) player, or the like. An application that supports a virtual scene, such as an application that supports a three-dimensional virtual scene, is installed and run on the terminal device. The application may be any one of a virtual reality (VR for short) application, an augmented reality (AR for short) program, a three-dimensional map program, a simulation game (SLG for short), or a multiplayer online battle arena game (MOBA for short). In one embodiment, the application may be a console version of an application, such as a console version of a three-dimensional game program, or may be an online version of an application. For example, the server provides a background service for the application on the terminal device.

FIG. 2 is a block diagram of a structure of an electronic device according to an embodiment of this disclosure. The electronic device 200 includes: an operating system 220 and an application 222.

The operating system 220 is basic software that enables secure access of the application 222 to computer hardware.

The application 222 is an application that supports a virtual scene. In one embodiment, the application 222 is an application that supports a three-dimensional virtual scene. The application 222 may be any one of a virtual reality application, a three-dimensional map program, a third-person shooting (TPS for short) game, a first-person shooting (FPS for short) game, a MOBA game, or an SLG game. The application 222 may be a console version of an application, such as a console version of a three-dimensional game program, or may be an online version of an application.

FIG. 3 is a block diagram of a structure of a computer system according to an embodiment of this disclosure. The computer system 300 includes: a first device 320, a server 340, and a second device 360.

An application that supports a virtual scene is installed and run on the first device 320. The application may be any one of a virtual reality application, a three-dimensional map program, a TPS game, an FPS game, a MOBA game, or an SLG game. The first device 320 is a device used by a first user. The first user uses the first device 320 to control a first virtual object in the virtual scene to carry out an activity. The activity includes but is not limited to: at least one of adjusting a body posture, crawling, walking, running, riding, jumping, driving, picking up, shooting, attacking, or throwing. For example, the first virtual object is a first virtual character, such as a simulation character or an animation character.

The first device 320 is connected to the server 340 over a wireless network or a wired network.

The server 340 includes at least one of a server, a plurality of servers, a cloud computing platform, or a virtualization center. The server 340 is configured to provide a background service for an application that supports a three-dimensional virtual scene. In one embodiment, the server 340 undertakes primary computing work, and the first device 320 and the second device 360 undertake secondary computing work. Alternatively, the server 340 undertakes secondary computing work, and the first device 320 and the second device 360 undertake primary computing work. Alternatively, the server 340, the first device 320, and the second device 360 performs collaborative computing by using a distributed computing architecture.

An application that supports a virtual scene is installed and run on the second device 360. The application may be any one of a virtual reality application, a three-dimensional map program, an FPS game, a MOBA game, or an SLG game. The second device 360 is a device used by a second user. The second user uses the second device 360 to control a second virtual object in the virtual scene to carry out an activity. The activity includes but is not limited to: at least one of adjusting a body posture, crawling, walking, running, riding, jumping, driving, picking up, shooting, attacking, or throwing. For example, the second virtual object is a second virtual character, such as a simulation character or an animation character.

In some embodiments, the first virtual character and the second virtual character are in the same virtual scene. In one embodiment, the first virtual character and the second virtual character may belong to the same team or the same organization, or have a friendship or a temporary communication permission. In one embodiment, the first virtual character and the second virtual character may alternatively belong to different teams, different organizations, or two opposing groups.

In some embodiments, the applications installed on the first device 320 and the second device 360 are the same, or the applications installed on the two devices are the same type of applications from different control system platforms. The first device 320 may refer to one of a plurality of devices, and the second device 360 may refer to one of a plurality of devices. In this embodiment, only the first device 320 and the second device 360 are used as examples for description. A device type of the first device 320 is the same as or different from that of the second device 360. The device type includes: at least one of a game console, a desktop computer, a smartphone, a tablet computer, an e-book reader, an MP3 player, an MP4 player, or a portable laptop computer. An example in which the device is a desktop computer is used for description in the following embodiments. In some embodiments, the first device and the second device are the terminal devices mentioned in the foregoing embodiments.

A person skilled in the art may know that a quantity of the foregoing devices may be more or less. For example, there may be only one device, dozens of devices, hundreds of devices, or more. The quantity and type of the device are not limited in embodiments of this disclosure.

The foregoing server 340 may be implemented as a physical server or as a cloud server in the cloud. A cloud technology is a hosting technology that unifies a series of resources such as hardware, software, and a network within a wide area network or local area network to implement data calculation, storage, processing, and sharing. The cloud technology is a general term of network technologies, information technologies, integration technologies, management platform technologies, application technologies, and other technologies applied to a cloud computing business model, and creates a resource pool to satisfy what is needed in a flexible and convenient manner. A cloud computing technology is to be the backbone. A lot of computing resources and storage resources are needed for background services in a technical network system, such as video websites, picture websites and other portal websites. With advanced development and application of the Internet technologies, all objects are likely to have their own identification flag in the future. These flags need to be transmitted to a background system for logical processing. Data of different levels is to be processed separately. Therefore, data processing in all industries requires support of a powerful system, and may be implemented through cloud computing.

In some embodiments, the foregoing server 340 may alternatively be implemented as a node in a blockchain system.

In some embodiments, the method provided in embodiments of this disclosure may be applied in a cloud game scene. The cloud server completes calculation of data logic during a game process, and the terminal device is responsible for display of a game interface.

Information (including but not limited to user equipment information, users' personal information, and the like), data (including but not limited to data used for analysis, stored data, displayed data, and the like), and signals involved in this disclosure are all authorized by users or fully authorized by all parties, and collection, use, and processing of related data need to comply with relevant laws, regulations, and standards of relevant countries and regions. For example, game data involved in this disclosure is obtained under full authorization.

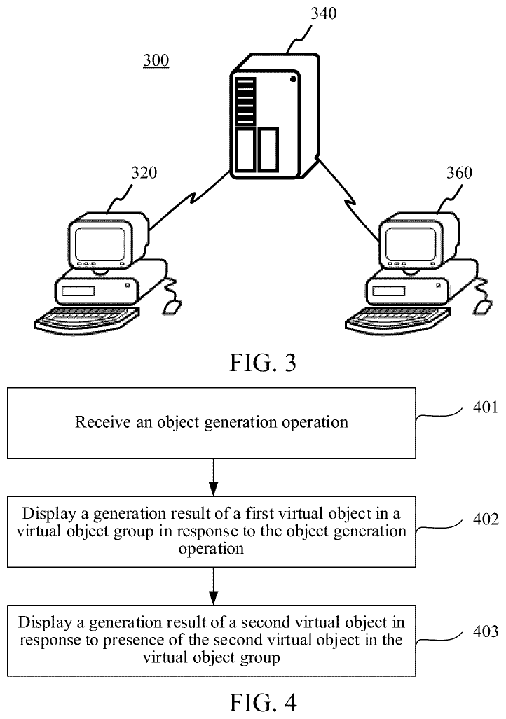

a virtual object generation method provided in embodiments of this disclosure is described in combination with the foregoing descriptions about terms and implementation environments. FIG. 4 is a flowchart of a virtual object generation method according to an embodiment of this disclosure. An example in which the method is applied to a terminal device is used for description. For example, operations in the method may be performed by the first device 320 or the second device 360 in the computer system shown in FIG. 3. For example, the operations are performed by a client of an application installed on the first device 320 or the second device 360. In the following method embodiments, for convenience of description, an example in which the operations are performed by a “client” is used for description. As shown in FIG. 4, the method includes at least one of operation 401 to operation 403.

Operation 401: Receive an object generation operation. In an example, an object generation operation is received from a user account to generate a virtual object group including a specified quantity of virtual objects to be controlled by the user account.

An object refers to a virtual object. The virtual object is in a virtual scene. Each virtual object is to be controlled by a control account corresponding to the virtual object to perform an operation specified by the control account.

The object generation operation is configured for giving an instruction for generation of a virtual object group including a specified quantity of virtual objects. In other words, the quantity of virtual objects in the virtual object group is a preset value. In some embodiments, the object generation operation is an operation for generating a virtual object in the virtual scene. For example, an object generation control is displayed on a user interface. The object generation control is a UI control, and the object generation operation is an operation performed on the object generation control. A type of the operation is not limited in this disclosure. For example, the operation includes but is not limited to tap/click, slide, double tap/click, touch and hold/long press, and the like.

In some embodiments, the quantity of virtual objects in the virtual object group is a user-defined value, or a value automatically set by a system. In this embodiment, an example in which the preset value is a user-defined value is used for description.

The virtual object group is configured for receiving control from the control account to engage in a virtual battle and perform the operation specified by the control account. For example, the virtual object group receives the control from the control account to engage in a virtual battle against another virtual object group. The control account may be considered to be any one of a user account of the application running on the first device or a user account of an application running on the second device, and may alternatively be considered to be another account. This is not limited in this disclosure.

In some embodiments, the virtual scene includes a virtual training camp and virtual objects. The virtual training camp is a virtual building. The virtual training camp includes candidate virtual objects. The candidate virtual objects may be trained in the virtual training camp to generate a virtual object group including a specified quantity of virtual objects. Alternatively, the candidate virtual objects may be trained in the virtual training camp to increase levels of the candidate virtual objects and enhance object attributes, skills, and the like of the candidate virtual objects.

After the object generation operation is received, the candidate virtual objects are instructed to be trained in the virtual training camp, to generate a virtual object group A. For example, the virtual object group A includes 20 virtual objects. The virtual object group A may receive control from the control account to engage in a virtual battle.

The virtual objects in the virtual object group A may be individually controlled by the control account to engage in a virtual battle or perform another operation, or may be uniformly controlled to engage in a virtual battle or perform another operation. The virtual objects in the virtual object group A may be combined with an existing virtual object that the control account possesses, to form a new virtual object group B. Virtual objects in the virtual object group B may be individually controlled by the control account to engage in a virtual battle or perform another operation, or may be uniformly controlled to engage in a virtual battle or perform another operation.

The foregoing virtual scene may include, but is not limited to, at least one of a virtual building, a virtual object, a virtual facility, a virtual city, a virtual article, or the like. This is not limited in this embodiment.

After the object generation operation is received, the virtual object group may be generated by training the candidate virtual objects in the virtual training camp, or the virtual object group may be generated without training the candidate virtual objects in the virtual training camp. After the object generation operation is received, if the virtual object group needs to be generated by training virtual objects in the virtual training camp, a process of generating the virtual object group includes but is not limited to the following two cases:
1. When virtual objects are present in the virtual training camp, the present candidate virtual objects in the virtual training camp may be trained to generate the virtual object group, and the virtual object group includes a preset quantity of virtual objects. In this case, the virtual objects in the virtual object group are different from a candidate virtual object that is not trained in the virtual training camp.
2. When there is no candidate virtual object in the virtual training camp, a preset quantity of virtual objects may be directly generated through training, so as to generate the virtual object group.

After the object generation operation is received, if the virtual object group can be generated without training the candidate virtual objects in the virtual training camp, the virtual object group is directly generated, and the virtual object group includes a preset quantity of virtual objects. This is not limited in this embodiment.

The quantity of the virtual objects in the virtual object group may be any preset value. The virtual object group may receive the control from the control account to perform any operation, including but not limited to: engaging in a virtual battle, constructing a virtual building, performing virtual training, and another operation. This is not limited in this embodiment.

Operation 402: Display a generation result of a first virtual object in the virtual object group in response to the object generation operation. In an example, when second virtual objects are determined to be generated as part of the virtual object group, a generation result of first virtual objects is displayed in the virtual object group based on the object generation operation and a generation result of second virtual objects is displayed. For example, a total quantity of the first virtual objects and the second virtual objects is the specified quantity of the virtual objects, whether the second virtual objects are to be generated in the virtual object group is determined based on one or more factors independent of the object generation operation, and a first object attribute information corresponding to the first virtual objects is different from a second object attribute information corresponding to the second virtual objects.

In some embodiments, the generation result of the first virtual object may be represented in the form of text or in the form of a picture. For example, when the generation result is in the form of text, the generation result may represent at least one of a quantity and an object attribute of the first virtual objects. For example, the generation result of the first virtual object is text displayed on the user interface, and text content is “10 soldiers are generated”. “10” represents the quantity of the first virtual objects, and “soldiers” represents the object attribute of the first virtual object. For example, when the generation result is in the form of a picture, the first virtual object generated in the virtual scene is directly mapped to the user interface, to obtain a display picture of the first virtual object displayed on the user interface. Each first virtual object in the virtual scene has a corresponding model architecture, which is rendered in advance by the application. For example, the generation result of the first virtual object is figures of ten soldiers displayed on the user interface. The generation result of the first virtual object in the virtual object group may also be referred to as a first object generation result. The first object generation result includes but is not limited to a display form (external form) of the first virtual object, a displayed quantity of the first virtual objects, a display location of the first virtual object, an object type of the first virtual object, and the like. Content included in the generation result of the first virtual object is not limited in this disclosure. All results related to the first virtual object may be included in the first object generation result.

In some embodiments, the virtual object group is considered as an object set that includes at least two virtual objects. A type of the virtual object is not limited. For example, the virtual object group includes at least one type of the virtual objects.

In this embodiment, a case where the virtual object group includes two types of the virtual objects is used for description, and the virtual objects of one of the types are the first virtual objects.

In some embodiments, a soldier type of the first virtual object is any one of an ordinary infantry, an ordinary cavalry, an ordinary chariot soldier, an ordinary sailor, or the like. In this embodiment, an example in which the soldier type of the first virtual object is the ordinary infantry is used for description. Certainly, the first virtual object may alternatively be of another soldier type. This is not limited in this disclosure. In some embodiments, the type of the first virtual object is set in advance. For example, when a user gives an instruction in advance that the type of the first virtual object in the virtual object group is the ordinary infantry, the soldier type of the generated first virtual object is the ordinary infantry.

In some embodiments, there are 19 first virtual objects in the virtual object group, and all the first virtual object have the same features and external form. The external form of the first virtual object is a virtual character holding a virtual weapon.

The first virtual object in the virtual object group may be any soldier type, including but not limited to any one of an ordinary infantry, an ordinary cavalry, an ordinary chariot soldier, an ordinary sailor, or the like. When the virtual object group includes a virtual object of another type, the virtual object of another type may be of any soldier type. This is not limited in this embodiment.

The quantity of the virtual objects in the virtual object group may be any preset value. If the virtual object group includes the first virtual object, a quantity of the first virtual objects may also be any value. The external form of the first virtual object may be any virtual character. If the first virtual object holds a virtual weapon, the virtual weapon held by the first virtual object may also be of any type. This is not limited in this embodiment.

Operation 403: Display a generation result of a second virtual object in response to presence of the second virtual object in the virtual object group.

The generation result of the second virtual object here may be analogous to the foregoing generation result of the first virtual object, and is not described again.

The second virtual object and the first virtual object are different types of virtual objects. For example, a difference between the first virtual object and the second virtual object lies in at least one of the following: a display form (external form), an object attribute, a location, or the like. The object attribute includes but is not limited to an attack attribute, a defense attribute, a skill type, and the like.

In some embodiments, the generation result of the second virtual object in the virtual object group may also be referred to as a second object generation result. The second object generation result includes but is not limited to a display form (external form) of the second virtual object, a quantity of the second virtual objects displayed, a display location of the second virtual object, an object type of the second virtual object, and the like. Content included in the generation result of the second virtual object is not limited in this disclosure. All results related to the second virtual object may be included in the second object generation result.

The virtual object group includes virtual objects of at least one type. The virtual object of each type has its own corresponding object attribute configured for identifying feature information of the virtual object. Each object attribute has its own corresponding experience points configured for identifying an object attribute level of each virtual object. Each virtual object further has its own skill attribute configured for indicating an attack method or a defense method that each virtual object may use during a virtual battle.

An object attribute type and the object attribute level of the virtual object are mainly configured for reflecting a combat level and a defense level of the virtual object. Alternatively, a battle situation is determined based on the object attribute type and the object attribute level of the virtual object during the virtual battle that the virtual object engages in.

In some embodiments, the virtual object may cause corresponding damage to an opposing virtual object during the virtual battle based on the object attribute type and values of object attributes of the virtual object; or may provide corresponding defense against damage caused by the opposing virtual object.

For virtual objects of the same type, object attribute types of the virtual objects are the same, and experience points corresponding to the object attributes are the same. In other words, the virtual objects of the same type have the same object attribute level.

In some embodiments, the virtual object group includes two types of virtual objects. To be specific, the virtual object group includes the first virtual object and the second virtual object.

In some embodiments, there are 20 virtual objects in the virtual object group, including 19 first virtual objects and one second virtual object.

A total quantity of the first virtual objects and the second virtual object is a specified quantity of the virtual objects included in the virtual object group, i.e., 20. The second virtual object is an object randomly generated in the virtual object group.

The difference between an object attribute corresponding to the first virtual object and an object attribute corresponding to the second virtual object includes but is not limited to at least one of the following cases:
1. A quantity of first object attribute types is different from a quantity of second object attribute types: The quantity of the first object attribute types is more than the quantity of the second object attribute types, or the quantity of the first object attribute types is less than the quantity of the second object attribute types.
2. The first object attribute types are the same as the second object attribute types, but values of the first object attribute types are different from values of the second object attribute types: The values of the first object attribute types are partially different from the values of the second object attribute types, or the values of the first object attribute types are different from the values of the second object attribute types. The object attribute of the first virtual object may also be referred to as a first object attribute, and an object attribute of the second virtual object may also be referred to as a second object attribute.

An object attribute type of the virtual object includes but is not limited to a health point, an attack damage, mana, an attack speed, armor, magic resistance, and the like. The object attribute of the virtual object includes at least one of the foregoing types.

The health point represents the remaining life of the virtual object, and is configured for indicating a degree of damage caused by an opposing virtual object to the virtual object when the virtual object participates in a virtual battle. If the health point is an initial value X, it indicates that the virtual object is not harmed. If the health point is 0, it indicates that the virtual object is harmed and eliminated. If the health point is a value within a range from 0 to X, it indicates that the virtual object is harmed but survived.

The armor represents a defense level of the virtual object and is configured for reducing a degree of damage caused by an opposing virtual object to the virtual object when the virtual object participates in a virtual battle. During the virtual battle, the armor of the virtual object is a fixed value.

The attack damage represents an attack level of the virtual object and is configured for representing a degree of damage caused by the virtual object to an opposing virtual object when the virtual object participates in a virtual battle. During the virtual battle, the attack damage of the virtual object is a fixed value.

The attack speed represents a speed of an attack of the virtual object, and is configured for indicating a quantity of damages caused by the virtual object to an opposing virtual object within a specific period of time when the virtual object participates in a virtual battle. During the virtual battle, the attack speed of the virtual object is a fixed value.

The mana represents a level of a skill used by the virtual object and is configured for enabling the virtual object to consume the mana to attack an opposing virtual object and cause damage by using skills when the virtual object participates in a virtual battle. During the virtual battle, the mana of the virtual object is a fixed value.

The magic resistance represents a magic defense level of the virtual object and is configured for reducing a degree of damage caused by a skill used by an opposing virtual object to the virtual object when the virtual object participates in a virtual battle. During the virtual battle, the magic resistance of the virtual object is a fixed value.

In some embodiments, all the first virtual objects in the virtual object group are of the same soldier type, i.e., are ordinary infantries. Each first virtual object includes the following six first object attributes: a health point, an attack damage, mana, an attack speed, armor, and magic resistance.

In some embodiments, a value of each first object attribute is 100. To be specific, first object experience points corresponding to the health point, attack damage, mana, attack speed, armor, and magic resistance of each first virtual object are 100.

In some embodiments, a soldier type of the second virtual object in the virtual object group is a heroic infantry. The second virtual object includes the following six second object attributes: a health point, an attack damage, mana, an attack speed, armor, and magic resistance.

In some embodiments, a value of each second object attribute is 200. To be specific, second object experience points corresponding to the health point, attack damage, mana, attack speed, armor, and magic resistance of each second virtual object are 200.

The external form of the second virtual object is different from the external form of the first virtual object.

In some embodiments, the external form of the first virtual object is smaller than the external form of the second virtual object, an outline of the first virtual object does not have a halo, and an outline of the second virtual object has a halo.

There may be any quantity of types of virtual objects in the virtual object group. The virtual object group may include any virtual object. To be specific, the virtual object group may include the first virtual object and the second virtual object, or may include only one of the first virtual object or the second virtual object, or may not include any one of the first virtual object and the second virtual object. The quantity of the virtual objects in the virtual object group may be any value. If the virtual object group includes the first virtual object and the second virtual object, the quantity of the first virtual objects and the quantity of the second virtual objects may be any value that does not exceed the quantity of virtual objects in the virtual object group. This is not limited in this embodiment.

There may be any quantity of types of the first object attributes of the first virtual object, including but not limited to at least one of a health point, an attack damage, mana, attack speed, armor, magic resistance, or another object attribute. The first object attribute of the first virtual object may also include an object attribute other than the foregoing object attributes. Values respectively corresponding to the first object attributes of the first virtual object may be any value. A first skill attribute of the first virtual object may be any skill. This is not limited in this embodiment.

There may be any quantity of types of the second object attributes of the second virtual object, including but not limited to at least two of a health point, an attack damage, mana, attack speed, armor, magic resistance, or another object attribute. The second object attribute of the second virtual object may also include an object attribute other than the foregoing object attributes. Values respectively corresponding to the second object attributes of the second virtual object may be any value. A second skill attribute of the second virtual object may be any skill. This is not limited in this embodiment.

Different types of virtual objects have different external forms, and the external form of the first virtual object is different from the external form of the second virtual object. In the foregoing example, the external form of the first virtual object is smaller than the external form of the second virtual object, the outline of the first virtual object does not have a halo, and the outline of the second virtual object has a halo. In some embodiments, a difference in the external form between the first virtual object and the second virtual object includes but is not limited to: at least one of a color, a size, a shape, an item held, having a halo or not, or being highlighted or not. There may also be any other types of differences in the external form. This is not limited in this embodiment.

The second object attribute of the second virtual object may be superior to the first object attribute of the first virtual object, or may be inferior to the first object attribute of the first virtual object. This is not limited in this embodiment.

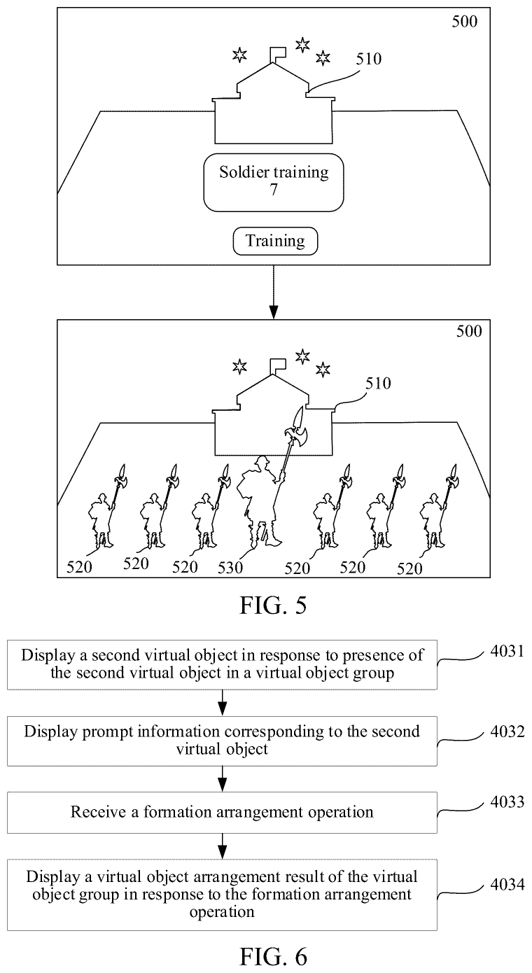

For example, FIG. 5 is a schematic diagram of a virtual object generation method according to an embodiment of this disclosure. As shown in FIG. 5,

there is a virtual training camp 510 in a virtual scene 500. After an object generation operation is received, virtual objects start to be trained in the virtual training camp 510, and a specified quantity of first virtual objects 520 and one second virtual object 530 are generated. An external form of the second virtual object 530 is different from that of the first virtual object 520. To be specific, the external form of the second virtual object 530 is larger than that of the first virtual object 520.

In conclusion, after the object generation operation is received, during training of the virtual objects, the first virtual objects may be generated, and one second virtual object may be generated randomly. The second virtual object has a second object attribute different from the object attribute of the first virtual object and an external form different from that of the first virtual object. The object attribute of the second virtual object may be superior to the object attribute of the first virtual object, or may be inferior to the object attribute of the first virtual object. In this way, randomness during generation of the virtual objects is increased, so that types of the virtual objects are diversified, and interestingness and topicality of controlling the virtual object to perform various operations are increased.

In some embodiments, if the second virtual object that is different from the first virtual object is present in the virtual object group, during displaying the generation result of the second virtual object, all virtual objects in the virtual object group need to be arranged in a preset sequence to emphasize the second virtual object. FIG. 6 is a flowchart of a method for displaying a generation result of a second virtual object according to another embodiment of this disclosure. An example in which the method is applied to a terminal device is used for description. For example, operations in the method may be performed by the first device 320 or the second device 360 in the computer system shown in FIG. 3. For example, the operations are performed by a client of an application installed on the first device 320 or the second device 360. In the following method embodiments, for convenience of description, an example in which the operations are performed by a “client” is used for description. As shown in FIG. 6, the foregoing operation 403 may alternatively be implemented as at least one of the following operation 4031 to operation 4034.

Operation 4031: Display the second virtual object in response to the presence of the second virtual object in the virtual object group. For example, the second virtual objects are displayed when at least one of the second virtual objects is detected in the virtual object group.

A display location of the second virtual object is not limited in embodiments of this disclosure. For example, the second virtual object is located at an arrangement center of the first virtual objects. For example, the second virtual object is located at a center of a range in which the virtual object group is located or at a location close to another virtual object group within the range in which the virtual object group is located.

In some embodiments, there are 20 virtual objects in the virtual object group, including 19 first virtual objects and one second virtual object.

In some embodiments, the first virtual objects are displayed in a distinguished manner from the second virtual object. A method for displaying in a distinguished manner is not limited in this embodiment of this disclosure. The method for displaying in a distinguished manner includes but is not limited to: using different colors, different sizes, different brightness, different special appearance effects, and the like.

In some embodiments, the second virtual object located at the arrangement center of the first virtual objects is displayed in an emphasis display mode. The emphasis display mode includes at least one of a magnification display mode, a highlight display mode, an outline flickering display mode, or a mark display mode.

In some embodiments, the second virtual object is located at the arrangement center of the first virtual objects in the magnification display mode.

A quantity of the virtual objects in the virtual object group may be any value. When quantities of virtual objects are different in the virtual object group, display sequences of the first virtual objects and the second virtual object are different, but the second virtual object is still located at the arrangement center of the first virtual objects.

When the second virtual object is present in the virtual object group, the second virtual object is located at the arrangement center of the first virtual objects in the emphasis display mode. The external form of the second virtual object is different from that of the first virtual object. The emphasis display mode of the second virtual object includes but is not limited to at least one of a magnification display mode, a highlight display mode, an outline flickering display mode, or a mark display mode, or may include another type of emphasis display mode. This is not limited in this embodiment.

FIG. 4032: Display prompt information corresponding to the second virtual object. For example, identification information corresponding to the second virtual objects is displayed, the identification information includes an identification code to identify the at least one of the second virtual objects.

In some embodiments, the prompt information is information related to the second virtual object. Content of the prompt information is not limited in this disclosure. For example, a type of the prompt information includes but is not limited to text information, picture information, voice information, and the like. In some embodiments, the prompt information includes an identification code. A type of the identification code in this disclosure includes but is not limited to a numeric identification code, a text identification code, a graphic identification code, and the like.

The prompt information corresponding to the second virtual object includes an identification code corresponding to the second virtual object. The identification code is configured for uniquely indicating the prompt information of the second virtual object. The prompt information is mainly configured for prompting that the second virtual object is generated in the virtual object group after the object generation operation is received.

In some embodiments, the prompt information corresponding to the second virtual object is text prompt information of “the second virtual object is obtained”, and is displayed at the upper center of a screen.

In some embodiments, the prompt information includes the identification code corresponding to the second virtual object. The identification code is a unique serial number of a generation sequence of the second virtual object. The unique serial number is 0089029 and includes seven digits.

The prompt information corresponding to the second virtual object may be displayed at any position on the screen, including but not limited to the upper center of the screen, the upper left corner of the screen, the upper right corner of the screen, the lower left corner of the screen, the lower right corner of the screen, or the like, and may alternatively be located at another position on the screen. The prompt information corresponding to the second virtual object may be prompt information in any form, including but not limited to at least one prompt information such as text prompt information, animation prompt information, or audio prompt information. If the prompt information is text prompt information, text content of the text prompt information may be at least one of any Chinese character, English character, special symbol, or any other text content. If the prompt information is animation prompt information, animation content of the animation prompt information may be any picture, and the animation prompt information may be of any content duration, in any color, and with any special effect. If the prompt information is audio prompt information, audio content of the audio prompt information may be at least one of any sound effect, music, voice fragment, or dialog. This is not limited in this embodiment.

The identification code corresponding to the second virtual object may be any information identifier that can uniquely indicate the second virtual object, including but not limited to the serial number of the generation sequence of the second virtual object, a serial number of a generation parameter of the second virtual object, and the like. If the identification code corresponding to the second virtual object is a unique serial number of the generation sequence of the second virtual object, the unique serial number may be a serial number including any digit, punctuation mark, English character, and the like. If the unique serial number includes a preset quantity of digits, the quantity of digits may be any quantity. This is not limited in this embodiment.

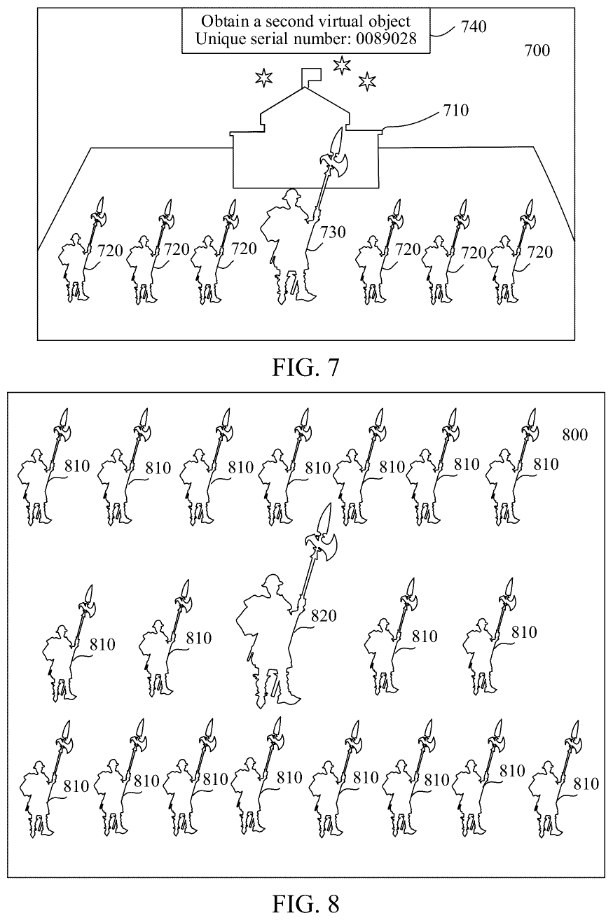

For example, FIG. 7 is a schematic diagram of displaying prompt information corresponding to a second virtual object according to an embodiment of this disclosure. As shown in FIG. 7,

there is a virtual training camp 710 in a virtual scene 700. After an object generation operation is received, a virtual object group is generated in this virtual training camp 710. The virtual object group includes a preset quantity of virtual objects, including first virtual objects 720 and a second virtual object 730. After the second virtual object 730 is generated, prompt information 740 corresponding to the second virtual object is text prompt information of “a second virtual object is obtained” and “unique serial number: 0089028”, and is displayed at the upper center of a screen to give a prompt that the second virtual object 730 has been generated, and an identification code of the second virtual object 730 is displayed.

Operation 4033: Receive a formation arrangement operation. For example, a formation arrangement operation is received, the formation arrangement operation arranges formation of the first virtual objects and the second virtual objects in the virtual object group.

In some embodiments, the formation arrangement operation is configured for configuring arrangement formation of the first virtual objects and the second virtual object in the virtual object group. For example, a formation arrangement control is displayed on a user interface, the formation arrangement control is a UI control, and the formation arrangement operation is an operation performed on the formation arrangement control. A type of the operation is not limited in this disclosure. For example, the operation includes but is not limited to tap/click, slide, double tap/click, touch and hold/long press, and the like.

The preset quantity of virtual objects is generated in the virtual object group in response to the object generation operation. When the virtual object group includes the first virtual objects and the second virtual object, because the external form of the first virtual object is different from the external form of the second virtual object, and the quantity of the first virtual objects is usually different from the quantity of the second virtual objects, the virtual objects in the virtual object group need to be arranged in a formation, and then the arranged virtual objects are displayed.

In some embodiments, there are 20 virtual objects in the virtual object group, including 19 first virtual objects and one second virtual object. After the formation arrangement operation is received, the arrangement formation of the virtual objects in the virtual object group is configured.

In some embodiments, the arrangement formation of the virtual objects is such that the second virtual object is located at the center of all virtual objects, and the first virtual objects are axisymmetrically distributed around the second virtual object.

After the formation arrangement operation is received, during configuring the arrangement formation of the virtual objects in the virtual object group, the arrangement formation of the virtual objects may be any formation. To be specific, the second virtual object may be located at the center of all virtual objects or at another location. The first virtual objects may surround the second virtual object or be located at other locations. This is not limited in this embodiment.

Operation 4034: Display a virtual object arrangement result of the virtual object group in response to the formation arrangement operation. For example, a virtual object arrangement result of the virtual object group is displayed in response to the formation arrangement operation.

The arrangement formation of the virtual objects in the virtual object group is configured based on a formation arrangement operation instruction in response to the formation arrangement operation. After the arrangement formation configuration is completed, all virtual objects in the virtual object group are displayed based on the arrangement formation.

In some embodiments, there are 20 virtual objects in the virtual object group, including 19 first virtual objects and one second virtual object. The arrangement formation of the virtual objects is such that the second virtual object is located at the center of all virtual objects, and the first virtual objects are axisymmetrically distributed around the second virtual object.

For example, FIG. 8 is a schematic diagram of a second virtual object located at an arrangement center of first virtual objects. As shown in FIG. 8,

there are 19 first virtual objects 810 and one second virtual object 820 in a virtual object group. Both the first virtual objects 810 and the second virtual object 820 are in a virtual scene 800. The second virtual object 820 is located at an arrangement center of all first virtual objects 810, and the first virtual objects 810 are axisymmetrically distributed around the second virtual object 820. An external form of the second virtual object 820 is larger than that of the first virtual object 810. In other words, the second virtual object 820 is located at the arrangement center of the first virtual objects 810 in a magnification display mode.

In conclusion, according to the method provided in embodiments of this disclosure, the first virtual objects and the second virtual object in the virtual object group are arranged, and the formation of the virtual objects is adjusted. In addition, the second virtual object is displayed in the emphasis display mode, to emphasize the second virtual object located among the first virtual objects, thereby increasing display orderliness of the virtual object group on the screen, and improving experience of a player controlling the virtual objects by using the control account.

According to the method provided in this embodiment, when the second virtual object is present in the virtual object group, the prompt about the presence of the second virtual object in the virtual object group is provided by displaying the second virtual object in the arrangement center of the first virtual objects and displaying the prompt information corresponding to the second virtual object. The prompt information further includes the identification code corresponding to the second virtual object. The identification code may be configured for uniquely indicating the second virtual object. In this way, the process of generating the virtual objects in the virtual object group is full of randomness, and the control account can also obtain information related to the second virtual object in a timely manner.

According to the method provided in this embodiment, when the second virtual object is present in the virtual object group, the second virtual object in the arrangement center of the first virtual objects is displayed in the emphasis display mode, so that the second virtual object can be seen more intuitively among a plurality of first virtual objects, and the external form of the second virtual object is different from the external form of the first virtual object. In this way, the control account can also obtain information related to the second virtual object in a timely manner.

According to the method provided in this embodiment, when the second virtual object is present in the virtual object group, the second object generation result is displayed. After the first virtual objects and the second virtual object are displayed on the screen, the formation arrangement operation is further received. The arrangement formation of the first virtual objects and the second virtual object in the virtual object group is configured through the formation arrangement operation, and the first virtual objects and the second virtual object arranged in the configured arrangement formation are displayed, so that orderliness of generation results of the virtual objects in the virtual object group is increased, and the second virtual object located among the first virtual objects is better emphasized.

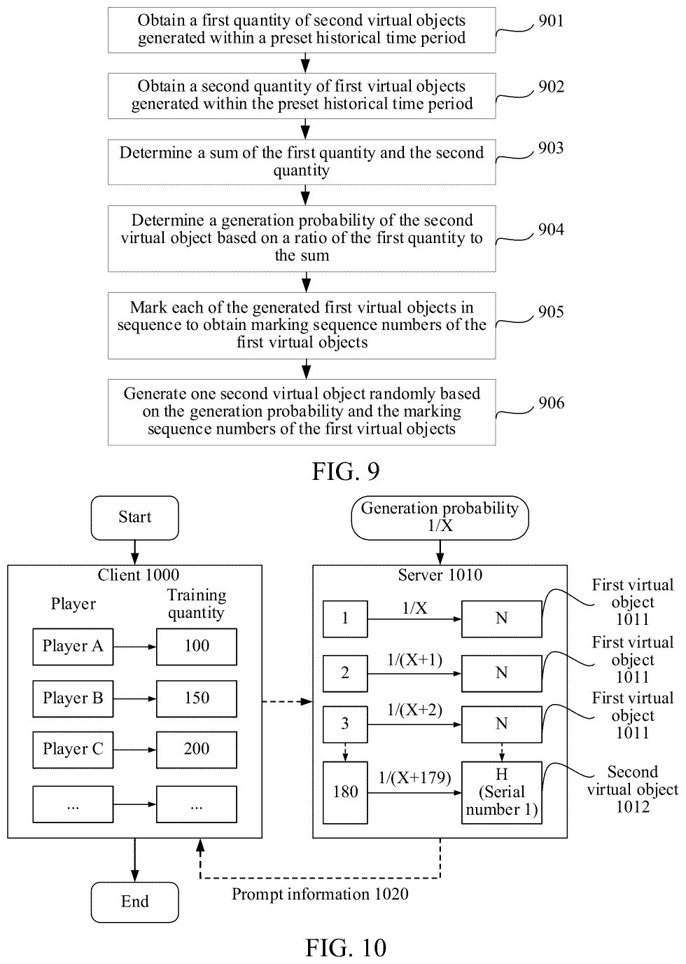

In some embodiments, after the object generation operation is received, the generated virtual object group usually does not include the second virtual object. In other words, a result of whether the virtual object group includes the second virtual object is random. FIG. 9 is a flowchart of a logical method for generating a first virtual object and a second virtual object according to another embodiment of this disclosure. An example in which the method is applied to a terminal device is used for description. For example, operations in the method may be performed by the first device 320 or the second device 360 in the computer system shown in FIG. 3. For example, the operations are performed by a client of an application installed on the first device 320 or the second device 360. In the following method embodiments, for convenience of description, an example in which the operations are performed by a “client” is used for description. As shown in FIG. 9, the method includes at least one of operation 901 to operation 906.

In some embodiments, a generation probability of the second virtual object is determined based on corresponding quantities of the first virtual objects and the second virtual objects generated within a preset historical time period. The generation probability of the second virtual object is configured for assisting in generating the second virtual object.

In some embodiments, a ratio of corresponding quantities of the first virtual objects and the second virtual objects generated within a current time period is determined based on a ratio of the corresponding quantities of the first virtual objects and the second virtual objects generated within the preset historical time period. In some embodiments, the ratio of the corresponding quantities of the first virtual objects and the second virtual objects generated within the preset historical time period is equal to the ratio of the corresponding quantities of the first virtual objects and the second virtual objects generated within the current time period. Within the current time period, the quantity of the second virtual objects is determined based on the quantity of the generated first virtual objects and the foregoing ratios.

In some other embodiments, the ratio of the corresponding quantities of the first virtual objects and the second virtual objects generated within the current time period is equal to the ratio of the corresponding quantities of the first virtual objects and the second virtual objects generated within the preset historical time period multiplied by an attenuation coefficient. For example, the attenuation coefficient is an exponential attenuation coefficient. In some embodiments, the ratio of the corresponding quantities of the first virtual objects and the second virtual objects generated within the preset historical time period multiplied by an attenuation coefficient is equal to the ratio of corresponding quantities of the first virtual objects and the second virtual objects generated within the current time period. For example, the attenuation coefficient is a constant.

In some other embodiments, the ratio of the corresponding quantities of the first virtual objects and the second virtual objects generated within the current time period is equal to the ratio of the corresponding quantities of the first virtual objects and the second virtual objects generated within the preset historical time period multiplied by a growth coefficient. For example, the growth coefficient is an exponential growth coefficient. In some embodiments, the ratio of the corresponding quantities of the first virtual objects and the second virtual objects generated within the preset historical time period multiplied by a growth coefficient is equal to the ratio of corresponding quantities of the first virtual objects and the second virtual objects generated within the current time period. For example, the growth coefficient is a constant.

A ratio of the quantity of the second virtual objects generated in the current time period to a total quantity of the first virtual objects and the second virtual objects generated in the current time period is equal to the generation probability of the second virtual object.

In this embodiment of this disclosure, the generation probability of the second virtual object within the current time period is determined based on the corresponding quantities of the first virtual objects and the second virtual objects within the preset historical time period, so that the determined generation probability of the second virtual object is more accurate and reasonable.

Operation 901: Obtain a first quantity of the second virtual objects generated within the preset historical time period. For example, a first quantity of the second virtual objects generated within the predetermined time period is obtained.

The preset historical time period refers to a past time period, and duration of the time period is a fixed preset value. Within the preset historical time period, the terminal device corresponding to a server not only receives an object generation operation instruction sent by a control account to perform a virtual object generation process, but also receives an object generation operation instruction sent by another account.

A total quantity of all second virtual objects generated in virtual object groups corresponding to all accounts within the preset historical time period is obtained. The second virtual object may appear in a virtual object group corresponding to any account.

In some embodiments, the preset time period is 24 hours, and the first quantity of all second virtual objects generated in the historical time period is 1. In other words, only one second virtual object is generated in the previous 24 hours.

Duration of the preset time period may be any preset duration. If the preset time period is 24 hours, the preset historical time period may be the previous 24 hours or an earlier historical time period. The first quantity of all second virtual objects generated in the historical time period may be any value. In other words, any quantity of the second virtual objects may be generated within the historical time period. This is not limited in this embodiment.

Operation 902: Obtain a second quantity of the first virtual objects generated within the preset historical time period. For example, a second quantity of the first virtual objects generated within the predetermined time period is obtained.

A total quantity of all first virtual objects generated in virtual object groups corresponding to all accounts within the preset historical time period is obtained. The first virtual object may appear in a virtual object group corresponding to any account.

In some embodiments, the preset time period is 24 hours, and the second quantity of all first virtual objects generated in the historical time period is 499. In other words, 499 first virtual objects are generated in the previous 24 hours.

Duration of the preset time period may be any preset duration. If the preset time period is 24 hours, the preset historical time period may be the previous 24 hours or an earlier historical time period. The second quantity of all first virtual objects generated in the historical time period may be any value. In other words, any quantity of the first virtual objects may be generated within the historical time period. This is not limited in this embodiment.

Operation 903: Determine a sum of the first quantity and the second quantity. For example, a sum of the first quantity and the second quantity is determined.

In some embodiments, types of all the virtual objects generated in the virtual object groups corresponding to all accounts within the preset historical time period are the first virtual object and the second virtual object. In other words, all the virtual objects generated within the preset historical time period include only the first virtual object and the second virtual object.

In some embodiments, there are a total of 500 virtual objects generated within the preset historical time period, including one second virtual object and 499 first virtual objects. In other words, the sum of the first quantity and the second quantity is 500.

Any quantity of virtual objects may be generated within the preset historical time period, and there may be any quantity of the first virtual objects and any quantity of the second virtual objects. This is not limited in this embodiment.

Operation 904: Determine the generation probability of the second virtual object based on a ratio of the first quantity to the sum. For example, the generation probability of the second virtual objects is determined based on a ratio of the first quantity to the sum of the first quantity and the second quantity.

The virtual objects generated within the preset historical time period are the first virtual object and the second virtual object. The quantity of the second virtual objects is the first quantity, and the sum of the quantity of the first virtual objects and the quantity of the second virtual objects is the total quantity of the virtual objects. The ratio of the first quantity to the sum is the generation probability of generating the second virtual object within a next preset time period.

Operation 905: Mark all the generated first virtual objects in sequence to obtain marking sequence numbers of the first virtual objects. For example, a marking sequence number of the first virtual objects is obtained by marking each of the first virtual objects generated in the virtual object group.

The object generation operation is received within the current preset time period, the first virtual objects are generated in the virtual object group corresponding to each account, and the first virtual objects are marked based on the generation probability of the second virtual object in a sequence of time when the first virtual objects are generated, so that each first virtual object has a unique marking sequence number. The marking sequence number is configured for uniquely identifying the first virtual object.

In some embodiments, there are a total of 500 virtual objects generated within the preset historical time period, including 499 first virtual objects and one second virtual object. Therefore, the generation probability of generating the second virtual object within the current preset time period is (1/500).

In some embodiments, a marking rule is as follows:

A marking sequence number of the first generated first virtual object is (1/500), indicating that the virtual object is the first generated first virtual object.

A marking sequence number of the second generated first virtual object is (1/501), indicating that the virtual object is the second generated first virtual object.

A marking sequence number of the third generated first virtual object is (1/502), indicating that the virtual object is the third generated first virtual object.

A marking sequence number of the fourth generated first virtual object is (1/503), indicating that the virtual object is the fourth generated first virtual object.

By analogy, a marking sequence number of an N^{th} generated first virtual object is (1/499+N), indicating that the virtual object is the N^{th} generated first virtual object. N is a positive integer.

There may be any quantity of the first virtual objects and any quantity of the second virtual objects generated within the preset historical time period. The generation probability of the second virtual object may be any non-negative value. The generation probability of the second virtual object does not exceed 1. The marking rule for the first virtual object within the preset historical time period may be any marking rule. In other words, the first virtual objects may be marked in sequence based on the generation probability of the second virtual object. Alternatively, the first virtual objects may be marked in sequence based on another rule. Alternatively, the first virtual objects may not be marked in sequence. Each first virtual object has a unique marking sequence number, and the marking sequence numbers of the first virtual objects are different. The marking sequence number may be any value or symbol and may be configured for uniquely identifying the first virtual object. This is not limited in this embodiment.

Operation 906: Generate one second virtual object randomly based on the generation probability and the marking sequence number of the first virtual object. For example, the second virtual objects are generated based on the generation probability and the marking sequence number of the first virtual objects.

A process of generating the second virtual object is random. The generation probability of the second virtual object is obtained based on the ratio of the quantity of the second virtual objects to the quantity of all virtual objects within the preset historical time period. The terminal device corresponding to the server randomly generates a second virtual object based on the generation probability of the second virtual object. For example, a total quantity of the first virtual objects is determined based on the generation probability, and when it is determined, based on the marking sequence number of the first virtual object, that the quantity of the generated first virtual objects is equal to the total quantity of the first virtual objects, the second virtual object is generated. For example, in the foregoing embodiment, when the marking sequence number of the first virtual object is 1/(499+499), it means that the first virtual object is the 499th first virtual object, and the virtual object to be generated next is the second virtual object.

At most one second virtual object is generated within the preset time period.

In some embodiments, the preset time period is 24 hours. In this preset time period of generating virtual objects, if a second virtual object is generated at the 18th hour of the preset time period, there is no further second virtual object to be generated in the remaining time of the preset time period, and only the first virtual objects are to be generated.

The duration of the preset time period may be any duration. There may be one or no second virtual object generated within the preset time period. If a second virtual object is generated, a time point at which the second virtual object is generated may be any time point within the preset time period. This is not limited in this embodiment.

For example, FIG. 10 is a logical schematic diagram of randomly generating a second virtual object according to an embodiment of this disclosure. As shown in FIG. 10,

players such as player A, player B, and player C of a client 1000 send object generation operation instructions. The instructions include a preset quantity of virtual objects to be generated. For example, a quantity of virtual objects corresponding to player A is 100, a quantity of virtual objects corresponding to player B is 150, and a quantity of virtual objects corresponding to player C is 200. A server 1010 receives object generation operation instructions from different players, and generates virtual objects through training. A type of the generated virtual object is a first virtual object, and a second virtual object is randomly generated.

The server 1010 obtains a generation probability (1/X) of the second virtual object within a previous preset historical time period, and marks the generated first virtual object based on the generation probability (1/X).

As shown in FIG. 10, after the object generation operation instruction is received, the first generated virtual object is a first virtual object 1011, and is marked with the generation probability (1/X) as a unique identifier of the first virtual object 1011. The second generated virtual object is still a first virtual object 1011 and is marked with (1/X+1). By analogy, an N^{th} generated first virtual object 1011 is marked with (1/X+N−1).

The 180th generated virtual object is a second virtual object 1012. The second virtual object 1012 is the first and the only second virtual object 1012 generated within the preset time period, and may be marked with (1/X+179). A serial number of the second virtual object 1012 is preset to 1.

After the second virtual object 1012 is generated, the server 1010 returns prompt information 1020 to the client 1000. The prompt information 1020 is configured for notifying all players of: the second virtual object 1012 is generated at a specific player, and no second virtual object 1012 is to be generated within the preset time period.

When the preset time period ends, a generation probability of the second virtual object 1012 is calculated based on quantities of the first virtual objects 1011 and the second virtual objects 1012 generated within the time period, and the generation probability is used as a reference in the next preset time period.

There may be any quantity of players in the client 1000, including but not limited to player A, player B, and player C. A quantity of generated virtual objects corresponding to each player is any non-negative integer. Duration of the preset time period may be any duration. The quantity of the second virtual objects 1012 generated within the preset time period is at most one. All the first virtual objects may be marked in any manner based on the generation probability (1/X) of the second virtual object 1012. The second virtual object 1012 may be marked based on the generation probability (1/X) of the second virtual object, or the second virtual object 1012 may be marked based on other information. This is not limited in this embodiment.

In conclusion, according to the method provided in embodiments of this disclosure, the quantity of the first virtual objects and the quantity of the second virtual objects generated within the preset historical time period are obtained to calculate the generation probability of the second virtual object. In addition, all first virtual objects in the next preset time period are marked based on the generation probability, and the second virtual object is randomly generated, so that each virtual object has a unique identifier. In this way, prediction of generation results of virtual objects within the next preset time period can be facilitated. In addition, all players are notified about whether the second virtual object is generated by returning the prompt information, thereby helping the players determine whether to continue to perform the object generation operation and plan subsequent operations appropriately. In this way, randomness and interestingness in a virtual object generation process are increased.

According to the method provided in this embodiment, the quantity of the first virtual objects and the quantity of the second virtual objects generated within the preset historical time period are obtained to calculate the generation probability of the second virtual object. The generation probability may be used as a unique identifier to mark all virtual objects and provide reference for generating the second virtual object within the next preset time period.

According to the method provided in this embodiment, during generating the first virtual objects, the first virtual objects are marked in a sequence of generation of the first virtual objects, and one second virtual object is randomly generated, so that randomness and interestingness in the virtual object generation process are increased.

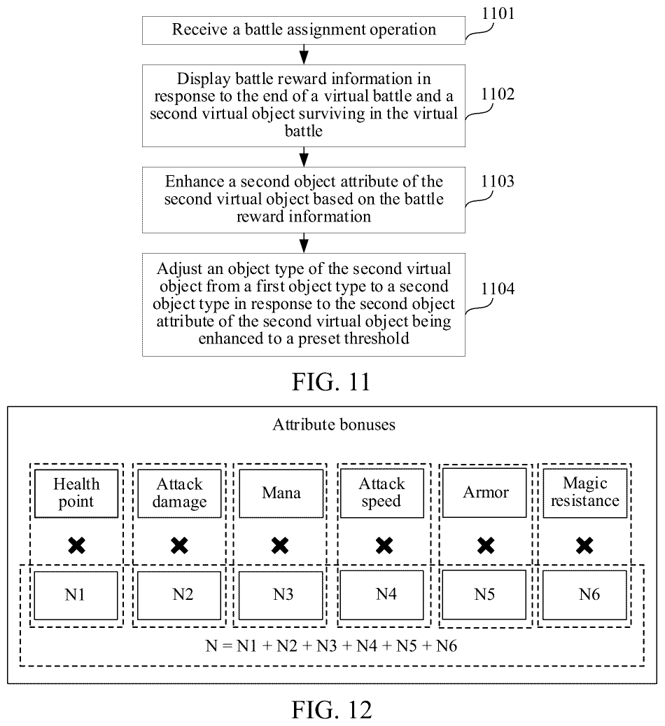

In some embodiments, after the second virtual object is generated, the second virtual object is usually controlled to participate in a virtual battle, so as to enhance a second object attribute of the second virtual object is enhanced and obtain experience points, so that the second virtual object grows. FIG. 11 is a flowchart of a growth method for a second virtual object participating in a virtual battle according to another embodiment of this disclosure. An example in which the method is applied to a terminal device is used for description. For example, operations in the method may be performed by the first device 320 or the second device 360 in the computer system shown in FIG. 3. For example, the operations are performed by a client of an application installed on the first device 320 or the second device 360. In the following method embodiments, for convenience of description, an example in which the operations are performed by a “client” is used for description. As shown in FIG. 11, the method includes at least one of operation 1101 to operation 1104.

Operation 1101: Receive a battle assignment operation. For example, a game assignment operation is received, the game assignment operation controls the first virtual objects and the second virtual objects in the virtual object group in a virtual game.

In some embodiments, the battle assignment operation is configured for controlling the first virtual objects and the second virtual object in the virtual object group to participate in the virtual battle. In other words, virtual objects in a home faction engage in a virtual battle against virtual objects in an opposing faction. For example, a battle assignment control is displayed on a user interface. The battle assignment control is a UI control, and the battle assignment operation is an operation performed on the battle assignment control. A type of the operation is not limited in this disclosure. For example, the operation includes but is not limited to tap/click, slide, double tap/click, touch and hold/long press, and the like.

The home faction refers to a player faction corresponding to the control account, and includes virtual objects generated based on an instruction of the control account and other content.

The home faction includes a first virtual object and a second virtual object, and the opposing faction may include at least one type of virtual objects in the first virtual object and the second virtual object.

In some embodiments, an external form of the second virtual object is larger than an external form of the first virtual object in the home faction. In other words, the external form of the second virtual object is different from the external form of the first virtual object.

In some embodiments, a soldier type of the first virtual object in a virtual object group of the home faction is an ordinary infantry. The first virtual object includes the following six first object attributes: a health point, an attack damage, mana, an attack speed, armor, and magic resistance.

In some embodiments, a value of each first object attribute is 100. To be specific, first object experience points corresponding to the health point, attack damage, mana, attack speed, armor, and magic resistance of each first virtual object are 100.

In some embodiments, a soldier type of the second virtual object in the virtual object group of the home faction is a heroic infantry. The second virtual object includes the following six second object attributes: a health point, an attack damage, mana, an attack speed, armor, and magic resistance.

In some embodiments, when a first object attribute type of the first virtual object and a second object attribute type of the second virtual object are the same, to balance features of the second virtual object and the first virtual object, the second object attribute of the second virtual object may be provided with an increase of experience points by N times, and the increase for attributes by N times may be freely allocated to all second object attributes.

In some embodiments, N is 20, and randomly allocating the increase of the experience points by 20 times to six second object attributes may include the following cases:
1. Second virtual object A: health point×2, attack damage×5, mana×3, attack speed×5, armor×2, and magic resistance×3. In other words, a value of the health point is 200, a value of the attack damage is 500, a value of the mana is 300, a value of the attack speed is 500, a value of the armor is 200, and a value of the magic resistance is 300.
2. Second virtual object B: health point×5, attack damage×3, mana×3, attack speed×2, armor×5, and magic resistance×2. In other words, a value of the health point is 500, a value of the attack damage is 300, a value of the mana is 300, a value of the attack speed is 200, a value of the armor is 500, and a value of the magic resistance is 200.

In other words, if the health points of the second virtual object is provided with an increase of the experience points by N1 times, the attack damage is provided with an increase of the experience points by N2 times, the mana is provided with an increase of the experience points by N3 times, the attack speed is provided with an increase of the experience points by N4 times, the armor is provided with an increase of the experience points by N5 times, and the magic resistance is provided with an increase of the experience points by N6 times. N=N1+N2+N3+N4+N5+N6.

For example, FIG. 12 is a schematic diagram of providing an increase of experience points for a second object attribute of a second virtual object by N times. As shown in FIG. 12,

the second virtual object is provided with an increase of second object experience points by N times: health point×N1, attack damage×N2, mana×N3, an attack speed×N4, armor×N5, and magic resistance×N6.

$$N = N 1 + N 2 + N 3 + N 4 + N 5 + N 6 .$$

The external forms of the second virtual object and the first virtual object may be any external form, and the external form of the second virtual object is necessarily different from the external form of the first virtual object. When the second object attribute of the second virtual object is the same as the first object attribute of the first virtual object, an increase of experience points by any amount may be provided for the second object attribute. This is not limited in this embodiment.

Operation 1102: Display battle reward information in response to the end of the virtual battle and the second virtual object surviving in the virtual battle. For example, reward information is displayed based on a result of the virtual game and the second virtual objects in the virtual game.

The battle reward information is configured for providing a prompt about reward experience points obtained by the second virtual object in the virtual battle, and the first virtual object does not obtain a reward in the virtual battle.

If the second virtual object survives in the virtual battle, the second virtual object may obtain the reward in the virtual battle. If the second virtual object dies in the virtual battle, the second virtual object no longer exists and cannot be revived or obtain the reward.

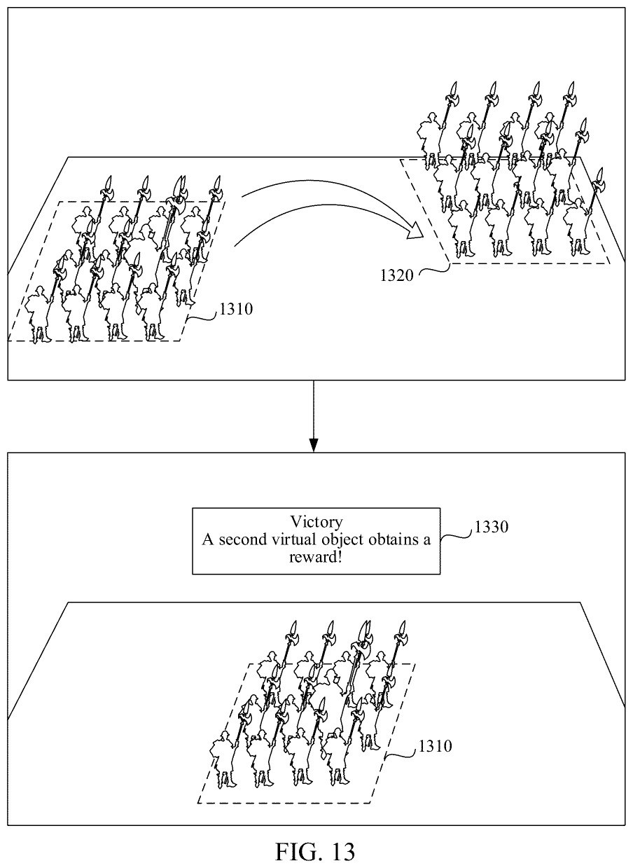

For example, FIG. 13 is a schematic diagram of virtual objects of a home faction defeating virtual objects of an opposing faction according to an embodiment of this disclosure. As shown in FIG. 13,

on the left is a virtual object group 1310 of the home faction, and on the right is a virtual object group 1320 of the opposing faction. After a battle assignment operation is received, the virtual object group 1310 of the home faction and the virtual object group 1320 of the opposing faction engage in a virtual battle. If the virtual object group 1310 of the home faction wins, and a second virtual object survives, then battle reward information 1330 is displayed. The battle reward information 1330 includes the following text content: “Victory”, “The second virtual object obtains a reward!”, to provide a prompt about the reward obtained by the second virtual object in the virtual battle.

Calculation logic of the battle reward information is as follows:
1. A battle scale of the virtual battle is obtained. The battle scale is obtained based on a quantity of the virtual objects in the virtual battle, that is, a total quantity of the virtual objects participating in the virtual battle, including the virtual objects of the home faction and the virtual objects of the opposing faction.
2. A degree of participation of the second virtual object in the virtual battle is obtained. The degree of participation is obtained based on a quantity of opposing virtual objects defeated by the second virtual object.
3. The battle reward information is displayed based on the battle scale and the degree of participation.

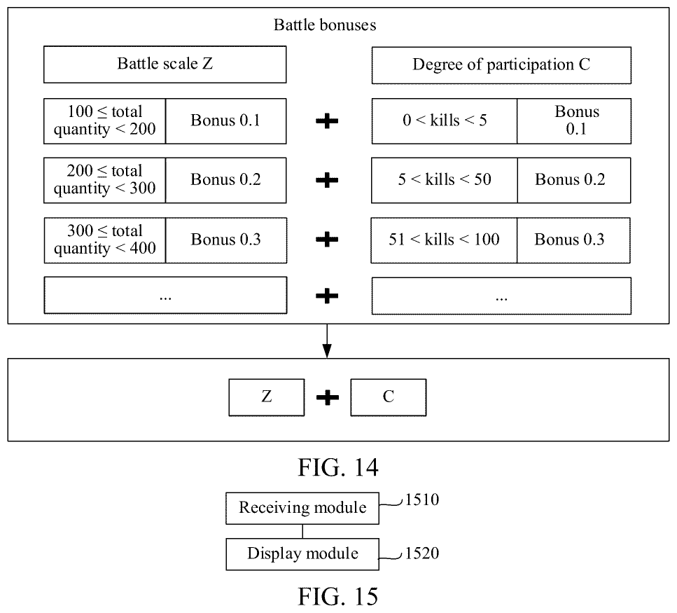

For example, FIG. 14 is a schematic diagram of battle reward information generation logic according to an embodiment of this disclosure. As shown in FIG. 14,
the sum of a quantity of the virtual objects in the home faction and a quantity of the virtual objects in the opposing faction is a total quantity P of the virtual objects.

When 0≤ the total quantity P<100, a proportion of an increase in experience points brought by a battle scale Z is 0.

When 100≤ the total quantity P<200, a proportion of an increase in experience points brought by the battle scale Z is 0.1.

When 200≤ the total quantity P<300, a proportion of an increase in experience points brought by the battle scale Z is 0.2.

When 300≤ the total quantity P<400, a proportion of an increase in experience points brought by the battle scale Z is 0.3.

By analogy, every time the total quantity P increases by 100, the proportion of the increase in experience points brought by the battle scale Z increases by 0.1.

The quantity of opposing virtual objects defeated by the second virtual object of the home faction in the virtual battle is a quantity S of kills.

When the quantity S of kills≤0, a proportion of an increase in experience points brought by a degree of participation C is 0.

When 0<the quantity S of kills≤5, a proportion of an increase in experience points brought by the degree of participation C is 0.1.

When 5<the quantity S of kills≤50, a proportion of an increase in experience points brought by the degree of participation C is 0.2.

When 51<the quantity S of kills≤100, a proportion of an increase in experience points brought by the degree of participation C is 0.3.

By analogy, every time the quantity S of kills increases by 50, the proportion of the increase in experience points brought by the degree of participation C increases by 0.1.

A proportion of an increase in overall experience points for the battle reward obtained based on the battle scale Z and the degree of participation C is a sum of the proportion of an increase in experience points brought by the battle scale and the proportion of an increase in experience points brought by the degree of participation.

In some embodiments, there are 60 virtual objects in the home faction and 50 virtual objects in the opposing faction. The quantity of the opposing virtual objects defeated by the second virtual object is 10.

A proportion of an increase in experience points brought by a battle scale of the second virtual object is 0.1, a proportion of an increase in experience points brought by a degree of participation of the second virtual object is 0.2, and a proportion of an increase in experience points for the battle reward is a sum of 0.1 and 0.2. In other words, in the battle reward information, a proportion of an increase in experience points for the battle reward of the second virtual object is 0.3.

The degree of participation of the second virtual object in the virtual battle may be obtained based on the quantity of the opposing virtual objects defeated by the second virtual object, or may be obtained based on another type of information. The battle scale of the virtual battle may be obtained based on the total quantity of the virtual objects in the home faction and the virtual objects in the opposing faction, or may be obtained based on another type of information. The battle reward information of the second virtual object may be obtained based on the sum of the proportion of the increase in experience points brought by the battle scale and the proportion of the increase in experience points brought by the degree of participation, or may be obtained by calculating according to different rules based on the proportion of the increase in experience points brought by the battle scale and the proportion of the increase in experience points brought by the degree of participation. This is not limited in this embodiment.

Operation 1103: Enhance the second object attribute of the second virtual object based on the battle reward information. For example, the second object attribute information of the second virtual objects is increased based on the reward information.

In some embodiments, there are 60 virtual objects in the home faction and 50 virtual objects in the opposing faction. The quantity of the opposing virtual objects defeated by the second virtual object is 10.

A proportion of an increase in experience points brought by a battle scale of the second virtual object is 0.1, a proportion of an increase in experience points brought by a degree of participation of the second virtual object is 0.2, and a proportion of an increase in experience points for the battle reward is a sum of 0.1 and 0.2. In other words, in the battle reward information, a proportion of an increase in experience points for the battle reward of the second virtual object is 0.3. In other words, a proportion of an increase in overall experience points of the second object attribute of the second virtual object is 30%, and each value of the second object attribute of the second virtual object is increased by 30%.

The second object attribute of the second virtual object is enhanced based on the battle reward information, and the overall experience points of the second object attribute may be increased. In other words, experience points of each second object attribute are increased by the same proportion. The experience points of each second object attribute may be increased randomly. In other words, a sum of a proportion of an increase in experience points of each second object attribute is a proportion of an increase in experience points in the battle reward information This is not limited in this embodiment.

Operation 1104: Adjust an object type of the second virtual object from a first object type to a second object type in response to the second object attribute of the second virtual object being enhanced to a preset threshold. For example, object type information of the second virtual objects is upgraded when the second object attribute information of the second virtual objects is increased to a predetermined threshold.

After participating in the virtual battle and surviving, the second virtual object obtains the battle reward, and the experience points of the second object attribute of the second virtual object are increased based on the battle reward.

The object type of the second virtual object is adjusted from the first object type to the second object type when the experience points of the second object attribute of the second virtual object are increased to a preset threshold. An object attribute of the first object type is different from an object attribute of the second object type. The second virtual object of an adjusted object type can be upgraded infinitely. In other words, a level of the second virtual object has no upper limit.

In some embodiments, a soldier type of the second virtual object in the virtual object group of the home faction is a heroic infantry. The second virtual object includes the following six second object attributes: a health point, an attack damage, mana, an attack speed, armor, and magic resistance.

In some embodiments, the experience points corresponding to each second object attribute are as follows: experience points of the health point are 500, experience points of the attack damage are 300, experience points of the mana are 300, experience points of the attack speed are 200, experience points of the armor are 500, and experience points of the magic resistance are 200.

In some embodiments, after the second virtual object participates in the virtual battle, an object attribute value of the second virtual object is increased accordingly. When the experience points corresponding to each second object attribute exceed a preset threshold of 10,000, the object type of the second virtual object is adjusted from the first object type to the second object type.

The second virtual object obtains corresponding experience points after participating in the virtual battle. When the accumulated experience points exceed the preset threshold, the object type of the second virtual object may be adjusted from the first object type to the second object type, or may still be remained as the first object type. The preset threshold is any value and exceeds the original experience points of the second object attribute of the second virtual object. This is not limited in this embodiment.

In conclusion, according to the method provided in embodiments of this disclosure, after the second virtual object is generated, the second virtual object is controlled to engage in the virtual battle. If the second virtual object survives, the second virtual object can obtain the battle reward in the virtual battle, and corresponding experience points is provided for the object attribute of the second virtual object, so that the second virtual object can grow. In this way, an inherent growth pattern of virtual objects is broken through, and the growth of the virtual object does not depend on a level of the control account or a level of a faction of the virtual object. The virtual object grows directly through the virtual battle, thereby increasing interestingness of controlling the virtual object in a battle process by a player, and increasing randomness in the growth of the virtual object.

According to the method provided in this embodiment, the first virtual object and the second virtual object are controlled to participate in the virtual battle after an instruction for the battle assignment operation is received. If the second virtual object survives, the corresponding battle reward can be obtained, thereby improving interestingness and experience of the player in controlling the virtual object to engage in the virtual battle.

According to the method provided in this embodiment, the battle scale of the virtual battle and the degree of participation of the second virtual object in the virtual battle are obtained and are displayed on a screen as a basis for providing corresponding experience points for the survived second virtual object after the virtual battle, to allow players to have a clearer understanding of a growth pattern and an upgrade mechanism of the second virtual object, thereby improving the experience of the player in controlling the virtual object to engage in the virtual battle.

According to the method provided in this embodiment, the second object attribute of the second virtual object is enhanced based on the battle reward information after the virtual battle ends, and corresponding experience points are provided for the second object attribute. In this way, the inherent growth pattern of the virtual object is broken through, and the growth of the virtual object does not depend on the level of the control account or the level of the faction of the virtual object, thereby making the growth pattern of the second virtual object full of randomness and interestingness, and improving the experience of the player in controlling the virtual object to engage in the virtual battle.

According to the method provided in embodiments of this disclosure, the object type of the second virtual object is adjusted from the first object type to the second object type based on that the second object attribute of the second virtual object is enhanced to the preset threshold. In this way, a basis is provided for the adjustment of the object type of the second virtual object, so that accuracy and efficiency of the adjustment of the object type of the second virtual object are improved.

Apparatus embodiments of this disclosure are described below, and may be used to implement the method embodiments of this disclosure. For details not disclosed in the apparatus embodiments of this disclosure, refer to the method embodiments of this disclosure.

FIG. 15 is a block diagram of a structure of a virtual object generation apparatus according to an embodiment of this disclosure. The apparatus has functions for implementing the foregoing method examples, and the functions may be implemented by using hardware, or may be implemented by using hardware executing corresponding software. The apparatus may be the terminal device according to the foregoing description, or may be disposed in the terminal device. As shown in FIG. 15, the apparatus includes:
a receiving module 1510, configured to receive an object generation operation, the object generation operation being configured for giving an instruction for generation of a virtual object group including a specific quantity of virtual objects, and the virtual object group being configured for receiving control from a control account to engage in a virtual battle; and
a display module 1520, configured to display a generation result of a first virtual object in the virtual object group in response to the object generation operation,
the display module 1520 being configured to display a generation result of a second virtual object in response to presence of the second virtual object in the virtual object group, a total quantity of the first virtual object and the second virtual object being a specified quantity, the second virtual object being a randomly generated object in the virtual object group, and an object attribute corresponding to the first virtual object being different from an object attribute corresponding to the second virtual object.

In some embodiments, the display module 1520 is further configured to display the second virtual object in response to the presence of the second virtual object in the virtual object group; and
the display module 1520 is further configured to display prompt information corresponding to the second virtual object, the prompt information including an identification code, and the identification code being configured for uniquely indicating the second virtual object.

In some embodiments, the display module 1520 is further configured to display, in an emphasis display mode in response to the presence of the second virtual object in the virtual object group, the second virtual object located at an arrangement center of the first virtual objects. The emphasis display mode includes at least one of a magnification display mode, a highlight display mode, an outline flickering display mode, or a mark display mode.

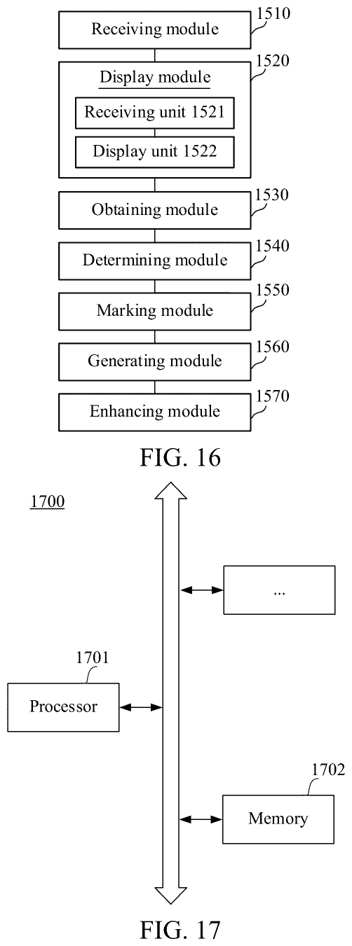

In some embodiments, as shown in FIG. 16, the display module 1520 includes:
a receiving unit 1521, configured to receive a formation arrangement operation, the formation arrangement operation being configured for configuring arrangement formation of the first virtual object and the second virtual object in the virtual object group; and
a display unit 1522, configured to display a virtual object arrangement result of the virtual object group in response to the formation arrangement operation.

In some embodiments, the apparatus further includes:
a determining module 1540, configured to determine a generation probability of the second virtual object based on corresponding quantities of the first virtual objects and the second virtual objects generated within a preset historical time period, the generation probability of the second virtual object being configured for assisting in generating the second virtual object.

In some embodiments, the apparatus further includes:
an obtaining module 1530, configured to obtain a first quantity of the second virtual objects generated within the preset historical time period.

The obtaining module 1530 further configured to obtain a second quantity of the first virtual objects generated within the preset historical time period.

The determining module 1540 is further configured to determine a sum of the first quantity and the second quantity.

The determining module 1540 is further configured to determine the generation probability of the second virtual object based on a ratio of the first quantity to the sum.

In some embodiments, the apparatus further includes:
a marking module 1550, configured to mark each of the generated first virtual objects in sequence to obtain a marking sequence number of the first virtual object; and
a generating module 1560, configured to generate one second virtual object randomly based on the generation probability and the marking sequence number of the first virtual object.

In some embodiments, as shown in FIG. 16, the display module 1520 includes:
the receiving unit 1521, further configured to receive a battle assignment operation, the battle assignment operation being configured for controlling the first virtual object and the second virtual object in the virtual object group to participate in the virtual battle; and
the display unit 1522, further configured to display battle reward information in response to the end of the virtual battle and the second virtual object surviving in the virtual battle.

In some embodiments, the display unit 1522 is further configured to obtain a battle scale of the virtual battle, the battle scale being obtained based on a quantity of the virtual objects in the virtual battle; obtain a degree of participation of the second virtual object in the virtual battle, the degree of participation being obtained based on a quantity of opposing virtual objects defeated by the second virtual object; and display the battle reward information based on the battle scale and the degree of participation.

In some embodiments, the apparatus further includes:
an enhancing module 1570, configured to enhance a second object attribute of the second virtual object based on the battle reward information.

In some embodiments, the enhancing module 1570 is further configured to adjust an object type of the second virtual object from a first object type to a second object type in response to the second object attribute of the second virtual object being enhanced to a preset threshold. An object attribute of the first object type is different from an object attribute of the second object type.

In conclusion, according to the apparatus provided in this embodiment of this disclosure, during training the virtual objects and generating the first virtual object, one second virtual object is randomly generated, and the second virtual object has a second object attribute and an external form different from an object attribute and an external form of the first virtual object. This increases randomness in growth of a virtual object, so that growth patterns of the virtual objects are diversified, and interestingness and topicality of controlling the virtual objects are increased.

Division of the functional modules of the virtual object generation apparatus provided in the foregoing embodiments is merely described as an example. In actual application, the foregoing functions may be assigned as needed to be implemented by different functional modules. In other words, an internal structure of a device is divided into different functional modules, to implement all or part of the functions described above. In addition, the virtual object generation apparatus provided in the foregoing embodiments and the virtual object generation method embodiments fall within the same concept. For details of the specific implementation process, refer to the method embodiments. Details are not described herein again.

FIG. 17 is a block diagram of a structure of a computer device 1700 according to an embodiment of this disclosure. The computer device 1700 may be: a smartphone, a tablet computer, a Moving Picture Experts Group Audio Layer III (MP3) player, a Moving Picture Experts Group Audio Layer IV (MP4) player, a notebook computer, or a desktop computer. The computer device 1700 may also be referred to as another name such as user equipment, a portable terminal device, a laptop terminal device, or a desktop terminal device.

The computer device 1700 includes: a processor 1701 (i.e., processing circuitry) and a memory 1702 (i.e., a non-transitory computer-readable storage medium).

The processor 1701 may include one or more processing cores, for example, a 4-core processor or an 8-core processor. The processor 1701 may be implemented in at least one hardware form of a digital signal processor (DSP), a field-programmable gate array (FPGA), and a programmable logic array (PLA). The processor 1701 may also include a main processor and a coprocessor. The main processor is a processor configured to process data in an awake state, and is also referred to as a central processing unit (CPU). The coprocessor is a low-power processor configured to process data in a standby state. In some embodiments, the processor 1701 may be integrated with a graphics processing unit (GPU). The GPU is configured to render and draw content that needs to be displayed on a display screen. In some embodiments, the processor 1701 may further include an AI processor. The AI processor is configured to process computing operations related to machine learning.

The memory 1702 may include one or more computer-readable storage media. The computer-readable storage medium may be non-transient. The memory 1702 may further include a high-speed random access memory and a nonvolatile memory, for example, one or more disk storage devices or flash storage devices. In some embodiments, the non-transitory computer-readable storage medium in the memory 1702 is configured to store at least one program, and the at least one program is configured to be executed by the processor 1701 to implement the virtual object generation method provided in the method embodiments of this disclosure.

In some embodiments, the computer device 1700 further includes another component. A person skilled in the art may understand that the structure shown in FIG. 17 does not constitute a limitation to the computer device 1700, and the computer device may include more components or fewer components than those shown in the figure, or some components may be combined, or a different component deployment may be used.

In some embodiments, the computer-readable storage medium may include: a read-only memory (ROM), a random access memory (RAM), a solid-state drive (SSD), an optical disc, or the like. The random access memory may include a resistance random access memory (RcRAM) and a dynamic random access memory (DRAM). The serial numbers of embodiments of this disclosure are merely for description, and do not represent the merits of embodiments.

An embodiment of this disclosure further provides a computer device. The computer device includes a processor and a memory. The memory has at least one program stored therein. The at least one program is loaded and executed by the processor to implement the virtual object generation method according to any one of embodiments of this disclosure.

An embodiment of this disclosure further provides a computer-readable storage medium. The storage medium has at least one program stored thereon. The at least one program is loaded and executed by a processor to implement the virtual object generation method according to any one of embodiments of this disclosure.

An embodiment of this disclosure further provides a computer program product. The computer program product includes a computer program, and the computer program is stored on a computer-readable storage medium. A processor of a computer device reads the computer program from the computer-readable storage medium, and the processor executes the computer program to enable the computer device to perform the virtual object generation method according to any one of the foregoing embodiments.

A person of ordinary skill in the art may understand that all or some of the operations of the foregoing embodiments may be implemented by hardware, or may be implemented by a program instructing relevant hardware. The program may be stored on a computer-readable storage medium. The storage medium may be a read-only memory, a magnetic disk, an optical disc, or the like.

The term “plurality of” mentioned in the specification means two or more. The term “and/or” describes an association relationship between associated objects and indicates that three relationships may exist. For example, A and/or B may indicate the following three cases: Only A exists, both A and B exist, and only B exists. The character “/” in this specification indicates an “or” relationship between the associated objects. In addition, the operation numbers described in this specification merely exemplarily show a possible execution sequence of the operations. In some other embodiments, the operations may not be performed according to the number sequence. For example, two operations with different numbers may be performed simultaneously, or two operations with different numbers may be performed according to a sequence contrary to the sequence shown in the figure. This is not limited in embodiments of this disclosure.

The foregoing disclosure includes some embodiments of this disclosure which, are not intended to limit the scope of this disclosure. Other embodiments shall also fall within the scope of this disclosure.

What is claimed is:

1. A virtual object generation method, comprising:
receiving, from a user account, an object generation operation to generate a virtual object group including a specified quantity of virtual objects to be controlled by the user account; and
when second virtual objects are determined to be generated as part of the virtual object group,
displaying a generation result of first virtual objects in the virtual object group based on the object generation operation; and
displaying a generation result of the second virtual objects, wherein
a total quantity of the first virtual objects and the second virtual objects is the specified quantity of the virtual objects, whether the second virtual objects are to be generated in the virtual object group is determined independent of the object generation operation, and a first object attribute information corresponding to the first virtual objects is different from a second object attribute information corresponding to the second virtual objects.

2. The method according to claim 1, wherein the displaying the generation result of the second virtual objects comprises:
displaying the second virtual objects when at least one of the second virtual objects is detected in the virtual object group; and
displaying identification information corresponding to the second virtual objects, the identification information includes an identification code to identify the at least one of the second virtual objects.

3. The method according to claim 2, wherein the displaying the second virtual objects comprises:
displaying the second virtual objects at a center of the first virtual objects, in a display mode to emphasize the second virtual objects when the second virtual objects are determined to be generated as part of the virtual object group, wherein,
the display mode includes at least one of a magnification display mode, a highlight display mode, an outline flickering display mode, and a mark display mode.

4. The method according to claim 3, further comprising:
receiving a formation arrangement operation, the formation arrangement operation arranges formation of the first virtual objects and the second virtual objects in the virtual object group; and
displaying a virtual object arrangement result of the virtual object group in response to the formation arrangement operation.

5. The method according to claim 4, further comprising:
determining a generation probability of the second virtual objects based on corresponding quantities of the first virtual objects and the second virtual objects generated within a predetermined time period, wherein the generation probability of the second virtual objects is used to generate the second virtual objects.

6. The method according to claim 5, wherein the determining the generation probability further comprising:
obtaining a first quantity of the second virtual objects generated within the predetermined time period;
obtaining a second quantity of the first virtual objects generated within the predetermined time period;
determining a sum of the first quantity and the second quantity; and
determining the generation probability of the second virtual objects based on a ratio of the first quantity to the sum of the first quantity and the second quantity.

7. The method according to claim 5, further comprising:
obtaining a marking sequence number of the first virtual objects by marking each of the first virtual objects generated in the virtual object group; and
generating the second virtual objects based on the generation probability and the marking sequence number of the first virtual objects.

8. The method according to claim 7, further comprising:
receiving a game assignment operation, the game assignment operation controls the first virtual objects and the second virtual objects in the virtual object group in a virtual game; and
displaying reward information based on a result of the virtual game and the second virtual objects in the virtual game.

9. The method according to claim 8, wherein the displaying the reward information further comprising:
obtaining scale information of the virtual game based on a quantity of the virtual objects in the virtual game;
obtaining degree of participation information of the second virtual objects in the virtual game based on a quantity of opposing virtual objects defeated by the second virtual objects; and
displaying the reward information based on the scale information and the degree of participation information.

10. The method according to claim 9, further comprising:
increasing the second object attribute information of the second virtual objects based on the reward information.

11. The method according to claim 10, further comprising:
upgrading object type information of the second virtual objects when the second object attribute information of the second virtual objects is increased to a predetermined threshold.

12. A virtual object generation apparatus, comprising:
processing circuitry configured to:
receive, from a user account, an object generation operation to generate a virtual object group including a specified quantity of virtual objects to be controlled by the user account; and
when second virtual objects are determined to be generated as part of the virtual object group,
display a generation result of first virtual objects in the virtual object group based on the object generation operation; and
display a generation result of the second virtual objects, wherein
a total quantity of the first virtual objects and the second virtual objects is the specified quantity of the virtual objects, whether the second virtual objects are to be generated in the virtual object group is determined based on one or more factors independent of the object generation operation, and a first object attribute information corresponding to the first virtual objects is different from a second object attribute information corresponding to the second virtual objects.

13. The virtual object generation apparatus according to claim 12, wherein the processing circuitry is configured to:
display the second virtual objects when at least one of the second virtual objects is detected in the virtual object group; and
display identification information corresponding to the second virtual objects, the identification information includes an identification code to identify the at least one of the second virtual objects.

14. The virtual object generation apparatus according to claim 13, wherein the processing circuitry is configured to:
display the second virtual objects at a center of the first virtual objects, in a display mode to emphasize the second virtual objects when the second virtual objects are determined to be generated as part of the virtual object group, wherein,
the display mode includes at least one of a magnification display mode, a highlight display mode, an outline flickering display mode, and a mark display mode.

15. The virtual object generation apparatus according to claim 14, wherein the processing circuitry is configured to:
receive a formation arrangement operation, the formation arrangement operation arranges formation of the first virtual objects and the second virtual objects in the virtual object group; and
display a virtual object arrangement result of the virtual object group in response to the formation arrangement operation.

16. The virtual object generation apparatus according to claim 15, wherein the processing circuitry is configured to:
determine a generation probability of the second virtual objects based on corresponding quantities of the first virtual objects and the second virtual objects generated within a predetermined time period, wherein the generation probability of the second virtual objects is used to generate the second virtual objects.

17. The virtual object generation apparatus according to claim 16, wherein the processing circuitry is configured to:
obtain a first quantity of the second virtual objects generated within the predetermined time period;
obtain a second quantity of the first virtual objects generated within the predetermined time period;
determine a sum of the first quantity and the second quantity; and
determine the generation probability of the second virtual objects based on a ratio of the first quantity to the sum of the first quantity and the second quantity.

18. The virtual object generation apparatus according to claim 16, wherein the processing circuitry is configured to:
obtain a marking sequence number of the first virtual objects by marking each of the first virtual objects generated in the virtual object group; and
generate the second virtual objects based on the generation probability and the marking sequence number of the first virtual objects.

19. The virtual object generation apparatus according to claim 18, wherein the processing circuitry is configured to:
receive a game assignment operation, the game assignment operation controls the first virtual objects and the second virtual objects in the virtual object group in a virtual game; and
display reward information based on a result of the virtual game and the second virtual objects in the virtual game.

20. A non-transitory computer-readable storage medium storing instructions which, when executed by a processor, cause the processor to perform:
receiving, from a user account, an object generation operation to generate a virtual object group including a specified quantity of virtual objects to be controlled by the user account; and
when second virtual objects are determined to be generated as part of the virtual object group,
displaying a generation result of first virtual objects in the virtual object group based on the object generation operation; and
displaying a generation result of the second virtual objects, wherein
a total quantity of the first virtual objects and the second virtual objects is the specified quantity of the virtual objects, whether the second virtual objects are to be generated in the virtual object group is determined based on one or more factors independent of the object generation operation, and a first object attribute information corresponding to the first virtual objects is different from a second object attribute information corresponding to the second virtual objects.
